(19) United States
(12) Patent Application Publication
(10) Pub. No.: US 2004/0259540 A1
(43) Pub. Date: Dec. 23, 2004

(54) Method and apparatus for providing an indication of a reason for a power-off state of a mobile communication device

(75) Inventors: Dwip N. Banerjee, Austin, TX (US); Lilian Sylvia Fernandes, Austin, TX (US); Vinit Jain, Austin, TX (US); Vasu Vallabhaneni, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY (US)

(21) Appl. No.: 10/464,890

(22) Filed: Jun. 19, 2003

(51) Int. Cl. H04Q 7/20

(52) U.S. Cl. 455/425; 455/414.1; 455/574

(57) ABSTRACT

A mechanism for a user of a mobile communication device to identify the reason for a power-off state of a mobile communication device and have that reason provided to authorized parties attempting to contact the user via the mobile communication device is provided. In addition, the reason for the power-off of the mobile communication device may be automatically determined based on the type of automatic power-off function being used by the mobile communication device.

### BACKGROUND OF THE INVENTION

1. Technical Field

The present invention is directed to an improved method and apparatus for informing parties of the unavailability of a party with which communication is sought. More specifically, the present invention is directed to a method and apparatus for providing an indication of a reason for a power-off state of a mobile communication device to a communication initiating party.

2. Description of Related Art

Mobile telephones and mobile communication devices have quickly become a staple of modern society. These mobile communication devices, e.g., cellular telephones, pagers, and other wireless communication devices, typically run on battery power and must be charged periodically in order to allow for continued functioning of the device. In order to conserve battery power, users of such devices will typically power-off their communication devices when they are not concerned about missing calls or when they are not in use. In addition, many of these devices have automatic power-off functions that are used to power-off the communication device in order to conserve residual battery power so that memory contents are not lost due to a lack of battery power.

In addition, there are many situations in which users of communications devices are asked to power-off their communications devices by other persons. For example, wireless communications devices are often prohibited in hospital areas, on airplanes, and the like. In addition, there are some situations in which the user of the communication device may wish to power-off the communication device as a courtesy to others, e.g., in theaters, meetings, at social functions, and the like.

During periods in which a communication device is in a power-off state, callers or initiators of communications with the communication device are either denied communication or are redirected to an automated voice mail system with which they may leave a message. The caller will typically not know that the communication device has been powered-off and will not know the reason for such powering-off. Rather, the handling of the call, to the caller, appears the same as if the communication device were powered-on and the user simply is not able to answer the communication request.

Thus, it would be beneficial to have a method and apparatus that allows a user of a communication device to indicate a reason for power-off of the communication device such that this reason may be provided to authorized individuals when they attempt a communication with the communication device.

### SUMMARY OF THE INVENTION

The present invention provides a mechanism for a user of a mobile communication device to identify the reason for a power-off of the mobile communication device and have that reason provided to parties attempting to contact the user via the mobile communication device. In addition, the reason for the power-off of the mobile communication device may be automatically determined based on the type of automatic power-off function being used by the mobile communication device.

With the apparatus and method of the present invention, when a user of a mobile communication device wishes to place the mobile communication device in a power-off state, or if the mobile communication device is automatically placed in a power-off state, a message may be transmitted to a mobile communication service provider computing device indicating the reason for the power-off condition. For automatic power-off operations, the mobile communication device itself may determine the reason for the power-off, e.g., low battery power, and may transmit the message with an indicator of the reason for the power-off state to the service provider computing device.

For user initiated power-off operations, the user may be presented with one or more display screens on his/her mobile communication device that allows the user to select the reason associated with why the user is powering-off the mobile communication device, e.g., “in a meeting,” “in a prohibited area,” “do not wish to be disturbed,” etc. Each of these possible reasons may have an associated identifier which may be included in a power-off message sent to a service provider computing device.

This identifier may then be stored in an entry associated with the mobile communication device in a register. When a communication attempt is made to the mobile communication device, the register is queried to determine the current state of the mobile communication device. If the register entry for the mobile communication device indicates that the mobile communication device is powered-off, the identifier may be retrieved and used to determine an automatic message to be returned to an authorized initiator of the communication attempt. In this way, an authorized initiator of a communication attempt to a powered-off mobile communication device may be informed of the fact that that mobile communication device is powered off and the reason why the mobile communication device is powered off.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a communication system in which the present invention may be implemented;

FIG. 2 is an exemplary message flow diagram illustrating the powering-off and powering-on of a communication device in accordance with the present invention;

FIG. 3 is an exemplary diagram of an initial display screen of a communication device in accordance with the present invention;

FIG. 4 is an exemplary diagram of a display screen of a communication device generated in response to a command to power-off the communication device;

FIG. 5 is an exemplary diagram of a display screen of a communication device through which a reason for the powering-off of the communication device may be selected;

FIG. 6 is an exemplary block diagram of a communication device in accordance with one embodiment of the present invention;

FIG. 7 is an exemplary block diagram of the primary operational elements of a service provider computing device in accordance with one embodiment of the present invention;

FIG. 8 is a flowchart outlining an exemplary operation of the present invention for handling a power-off of a communication device; and

FIG. 9 is a flowchart outlining an exemplary operation of the present invention when handling a communication attempt to a communication device that has been powered-off.

### DETAILED DESCRIPTION OF THE PREFERRED EMBODIMENT

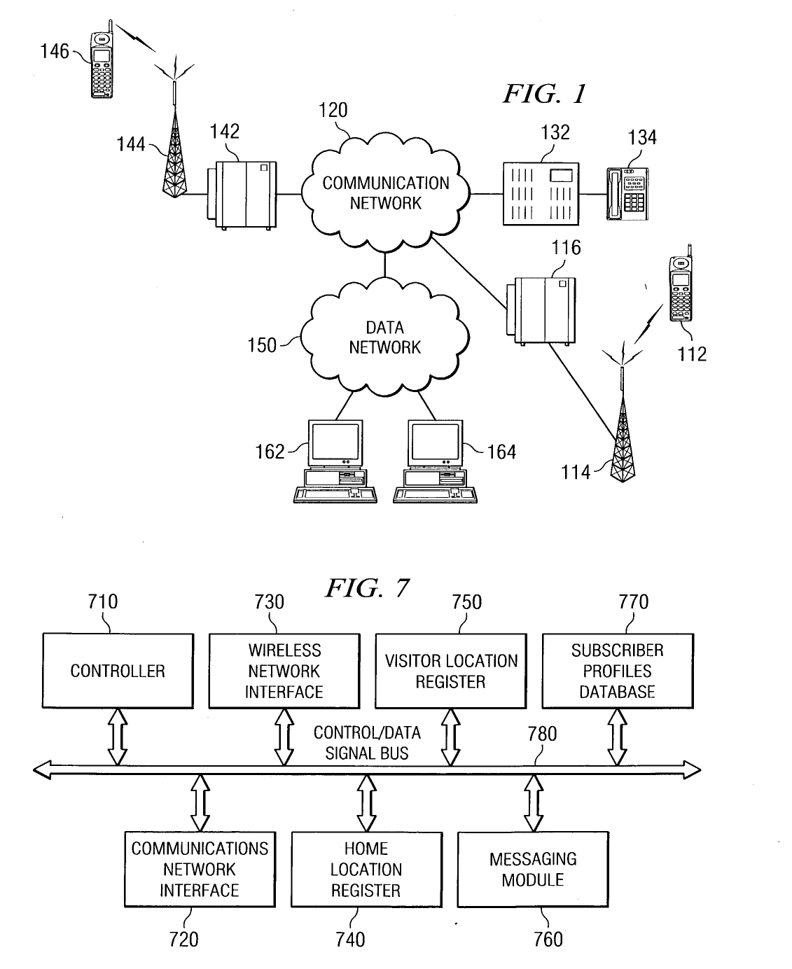

FIG. 1 is an exemplary diagram of a communication system in which the present invention may be implemented. As shown in FIG. 1, the communication system includes a first mobile communication device 112 which communicates with other communication devices via the communication network 120. As illustrated in FIG. 1, the mobile communication device 112 may be, for example, a wireless telephone, such as a cellular or digital spread spectrum telephone, a wireless pager device, or other wireless communication device.

The mobile communication device 112 transmits communication signals to, and receives communication signals from, the base station transceiver 114 via a wireless communication link. A service provider computing/communication system 116 is provided in association with the transceiver 114 for handling of communications between the mobile communication device 112 and other communications devices over the communication network 120. The service provider computing/communication system 116 has a computational ability and maintains data records regarding the mobile communication device 112 as well as other mobile communication devices in a wireless communication network serviced by the service provider computing/communication system 116. Such data records may include, for example, a home location register and a visitor location register, as are generally known in the art.

The communication network 120 may be, for example, a conventional wired telephone network, a fiber optic network, a wireless communication network, or the like. The communication network 120 may further be coupled to a data network 150 such that communications may be established with computing devices 162 and 164. Computing devices 162 and 164 may be, for example, personal computers, portable computers, personal digital assistants, or the like, which are equipped with voice data communication software, such as Internet telephony software, for example.

The mobile communication device 112 may communicate via the communication network 120 with a plurality of other communication devices including mobile communication device 146, wired telephone 134, and the computing devices 162 and 164. Mobile communication device 146 may be accessed via its own service provider computing/communication system 142 and base station 144. Wired telephone 134 may be access via an associated public branch exchange (PBX) or public switch 132.

With the apparatus and method of the present invention, when a user of mobile communication device 112, for example, wishes to place the mobile communication device 112 in a power-off state, or if the mobile communication device 112 is automatically placed in a power-off state, a message may be transmitted to the service provider computing device 116 indicating the reason for the power-off condition. For automatic power-off operations, the mobile communication device 112 itself may determine the reason for the power-off, e.g., low battery power, out of service region, no user input for a predetermined period of time, or the like, and may transmit the message with an indicator of the reason for the power-off state to the service provider computing device 116.

For user initiated power-off operations, the user may be presented with one or more display screens on the mobile communication device 112 that allows the user to select the reason associated with why the user is powering-off the mobile communication device 112, e.g., “in a meeting,” “in a prohibited area,” “do not wish to be disturbed,” etc. Each of these possible reasons may have an associated identifier which may be included in a power-off message sent to the service provider computing device 116.

This identifier may then be stored in an entry associated with the mobile communication device 112 in a register, e.g., home location register or visitor location register, of the service provider computing device 116. When a communication attempt is made to the mobile communication device 112 by another communication device, e.g., telephone 134, the register is queried to determine the current state of the mobile communication device 112. If the register entry for the mobile communication device 112 indicates that the mobile communication device is powered-off, the identifier may be retrieved and used to determine an automatic message to be returned to the initiator of the communication attempt, i.e. telephone 134. In this way, an initiator of a communication attempt to a powered-off mobile communication device 112 may be informed of the fact that that mobile communication device 112 is powered off and the reason why the mobile communication device is powered off.

Thus, for example, assume that a user of the mobile communication device 112 wishes to place the mobile communication device 112 in a power-off state. This may be done, for example, to conserve battery power, because the user and mobile communication device 112 are in a location where use of the mobile communication device 112 is prohibited, the user and the mobile communication device 112 are in a meeting or other gathering where use of the mobile communication device 112 is discouraged or would be seen as disruptive, or the like.

The user of the mobile communication device 112 may place the mobile communication device 112 in a power-off state by pressing a power button on the mobile communication device 112, selecting a power-off option from a displayed menu, or the like. In response to entering the power-off command, the mobile communication device 112 may present one or more display screens through which the user may select a reason for the powering-off of the mobile communication device 112. Such reasons may include, for example, “In Meeting,” “In Prohibited Location,” “Do not with to be Disturbed,” or the like. Moreover, the reasons may include instructions for callers to communicate with the user of the mobile communications device 112 via an alternative method, such as “Call me at home,” “Call me at work,” “Email me,” or the like.

The user selects the reason that is most appropriate for the user's current situation or circumstances. The selected reason is associated with an identifier of the reason which is encapsulated into a power-off message that is transmitted to a service provider computing device, such as service provider computing/communication device 116. The mobile communication device 112 is then powered-off.

At the service provider computing device 116, the power-off message and identifier are received. The power-off message further includes an identifier of the mobile communication device 112 which is used to access a record for the mobile communication device 112 in a stored register of mobile communication devices, e.g., a home location register or visitor location register. The service provider computing device 116 accesses the record for the mobile communication device 112 and updates the status of the mobile communication device 112 to be in a power-off state and stores the reason identifier in association with the record for the mobile communication device 112.

When a communication attempt is made to the mobile communication device 112, such as by wired telephone 134, for example, the service provider computing device 116 receives the communication attempt which includes an identifier of the mobile communication device 112 with which communication is sought. The service provider computing device 116 then performs a lookup in the register of the record for the mobile communication device 112 and determines the status of the mobile communication device 112.

Since the mobile communication device 112 is in a power-off state, the service provider computing device 116 determines the reason for the power-off state using the associated reason identifier. The service provider computing device 116 then determines if the initiator of the communication attempt may be informed of the reason for the power-off state. That is, the service provider computing device 116 may perform a lookup of a mobile communication device profile associated with the mobile communication device 112 to determine if the initiator, e.g., telephone 134, is listed in a block list, or alternatively, a reason permitted list, present in the profile.

If the initiator's identity, which is determined from the communication attempt message that includes an identifier of the initiator, is present in the block list, or alternatively, is not present in the reason permitted list, then the service provider computing device 116 does not inform the initiator of the reason for the power-off state but simply allows the communication attempt to be processed in a normal manner. This will typically involve the initiator's communication attempt being redirected to a voicemail or automatic answering service.

If the initiator's identity is either not in the block list, or alternatively, is present in the reason permitted list, then the service provider computing device 116 may announce to the initiator that the mobile communication device 112 is in a power-off state and the reason for the power-off state. Such announcements may be provided as prerecorded or automatically generated audible messages, prerecorded text messages, or the like. The prerecorded messages or prerecorded text messages may be standard messages provided by the service provider or may be messages that are generated by the user of the mobile communication device 112.

The particular prerecorded message used to announce the reason for the power-off state may be determined based on the reason identifier associated with the mobile communication device's record in the register. That is, the prerecorded messages are stored in a data structure in association with one or more reason identifiers. When determining which prerecorded message to output, the reason identifier stored in association with the mobile communication device's record in the registry is used to lookup an appropriate prerecorded message for output.

Thus, for example, if the user of the mobile communication device 112 selected the reason “In meeting” on the mobile communication device 112, the reason identifier “11” may have been sent in a power-off state message. This reason identifier “11” is stored in association with the mobile communication device's record in the registry and is retrieved when another communication device attempts to communicate with the mobile communication device 112. The reason identifier is then used to lookup a prerecorded message in a data structure. The reason identifier “11” is matched to a prerecorded message that announces audibly “I'm sorry, my phone is powered-off because I am in a meeting Please try back later today.”

When the user of the mobile communication device 112 decides to power-on the mobile communication device 112, the mobile communication device 112 performs a normal handshake operation. As part of this handshake operation, the present invention determines that the mobile communication device 112 is powered back on and resets the mobile communication device's state in the corresponding record in the registry. This process also reinitializes the reason identifier associated with the mobile communication device's record in the registry. Thus, a user need not perform any additional function on his/her mobile communication device 112 to remove the power-off state in the registry of the service provider computing device.

The example discussed above is illustrated in terms of the user selecting the reason for the power-off state, however the present invention is not limited to such. Rather, as mentioned previously, the mobile communication device 112 may alternatively, or in addition to the functionality discussed above, automatically detect the reason for a power-off state. For example, if the mobile communication device 112 is low on battery power, the mobile communication device 112 may automatically power-off and a corresponding reason of “low battery power” may be selected with its corresponding reason identifier being sent in a power-off message to a service provider computing device. Similarly, if the mobile communication device 112 is equipped with instructions for automatically powering-off when no input is received within a predetermined period of time, a corresponding reason for the powering off of the mobile communication device may be selected and an appropriate reason identifier sent to the service provider computing device. Other automatic power-off operations may have similar associated reason identifiers which may be sent to the service provider computing device in response to the automatic power-off operation being performed.

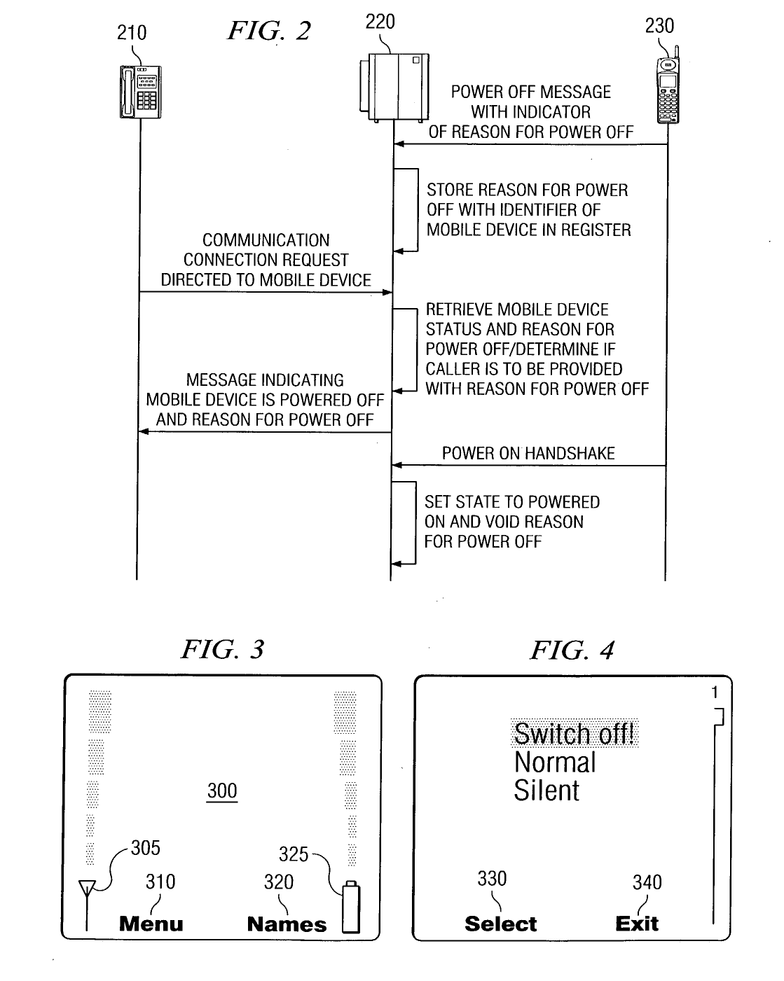

FIG. 2 is an exemplary message flow diagram illustrating the powering-off and powering-on of a communication device in accordance with the present invention. As shown in FIG. 2, the mobile communication device 230 sends a power-off message with an indicator of the reason for the power-off state to the service provider computing device 220. The service provider computing device 220 stores the state of the mobile communication device 230 along with the reason identifier in a record associated with the mobile communication device in a registry.

At some time later, a communication device 210 attempts a communication connection with the mobile communication device 230 by sending a communication connection request directed to the mobile communication device 210 to the service provider computing device 220. The service provider computing device 220 retrieves the mobile communication device 230 status and reason for the power-off state. The service provider computing device 220 also determines if the communication device 210 is permitted to have the reason for the power-off state announced to it.

Assuming that the communication device 210 is permitted to have the reason for the power-off stated announced to it, a message indicating that the mobile communication device 230 is powered-off and the reason for the power-off state. This process may be repeated for each incoming communication connection attempt until the state of the mobile communication device 230 is changed to a power-on state.

At some time later, the user of the mobile communication device 230 powers-on the mobile communication device 230 and a handshake operation is performed. In response to the handshake operation from the mobile communication device 230, the service provider computing device 220 resets the state of the mobile communication device to a power-on state and voids, i.e. reinitializes, the reason for the power-off state.

As discussed above, the present invention provides for a user of a mobile communication device to select a reason for a power-off state of the mobile communication device when powering-off the mobile communication device. In a preferred embodiment, the user may select this reason via display screens presented on the mobile communication device. FIGS. 3-5 provide exemplary illustrations of such display screens used to power-off a mobile communication device in accordance with one embodiment of the present invention.

FIG. 3 is an exemplary diagram of an initial display screen of a communication device in accordance with the present invention. The display screen 300 shown in FIG. 3 is a standard display screen found on many wireless telephones in use today. The display screen 300 includes an indicator 305 of signal strength, an indicator 325 of battery power, a selectable menu option 310 and a selectable names option 320. The menu option 310 may be selected by manipulating a corresponding button on a user interface of the mobile communication device. Similarly, the names option 320 may be selected by manipulating a corresponding button on a user interface of the mobile communication device.

With the present invention, a user may select the menu option 310 in order to be presented with a plurality of menu options, one of which may be to “switch off” or power-off the mobile communication device. Alternatively, the user may manipulate a power button of the mobile communication device in order to automatically be provided with the option to “switch off” or power-off the mobile communication device. In either case, the user is then presented with the display screen shown in FIG. 4.

FIG. 4 is an exemplary diagram of a display screen of a communication device generated in response to a command to power-off the communication device. As shown in FIG. 4, the display screen is changed to a menu list of options including “Switch Off,” “Normal,” “Silent,” and others that may require scrolling down the list. The user may use scroll buttons provided in the user interface of the mobile communication device to move the highlight of the menu option down the list to thereby select a different menu option. The user may then manipulate corresponding buttons to select either the “Select” option 330 or the “Exit” option 340 to either select the highlighted menu option or to exit back to the screen shown in FIG. 3.

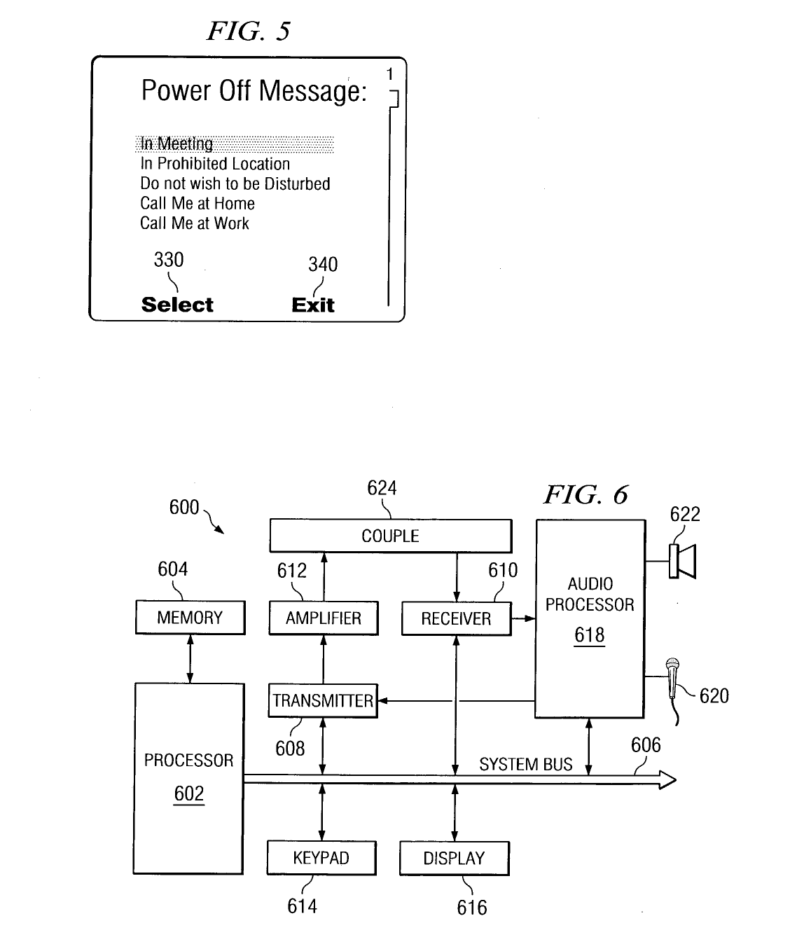

Assuming that the user selects the “Switch Off” option from the menu, the user is then presented with the display screen shown in FIG. 5. FIG. 5 is an exemplary diagram of a display screen of a communication device through which a reason for the powering-off of the communication device may be selected. As shown in FIG. 5, the display screen has changed to include a plurality of possible reasons for the powering-off of the mobile communication device. The list of reasons may be traversed in a similar manner as previously described and may include additional list entries that require scrolling down the list in order to be displayed. The highlighted list entry may be selected by pressing the appropriate user interface button associated with the “Select” option 330. Alternatively, the user may exit back to the display screen shown in FIG. 4 by pressing the appropriate user interface button associated with the “Exit” option 340.

In response to selecting a reason from the list in FIG. 5, the mobile communication device sends a power-off message to a service provider indicating the selected reason. In addition, the mobile communication device is powered-off.

FIG. 6 is an exemplary block diagram of a communication device in accordance with one embodiment of the present invention. Telephone device 600 includes a processor 602 for controlling operation of the telephone device and a memory 604. The processor 602 may be a general-purpose microprocessor operating under the control of instructions stored in a memory, such as memory 604, or device-specific circuitry for controlling the operation of the telephone device. Processor 602 is connected by system bus 606 to transmitter 608, receiver 610, keypad 614, display 616, and audio processor 618. Keypad 614 may be a physical keypad or a virtual keypad provided via a touch sensitive display and may include function buttons, pointing device controls, or other user interface peripheral elements commonly known in the art. Display 616 may include a liquid crystal display (LCD), plasma display, or other known type of display, such as a cathode ray tube, active matrix display, or the like.

Transmitter 608 and receiver 610 are coupled to a telephone signal by couple 624 to provide full duplex communication. The telephone signal may be provided by a telephone line (not shown) in a land-based telephone or an antenna in a wireless telephone. Audio processing circuit 618 provides basic analog audio outputs to speaker 620 and accepts analog audio inputs from microphone 622. Received signals are demodulated and decoded by receiver 610. Transmitter 608 encodes and modulates signals passed to it by processor 602 or audio processor 618. The output of the transmitter is amplified by power amplifier 612 to control the power level at which the signal is transmitted.

Those of ordinary skill in the art will appreciate that the hardware depicted in FIG. 6 is only exemplary and no limitation is intended or implied by the depiction in FIG. 6. Many modifications to the telephone device shown in FIG. 6 may be made without departing from the spirit and scope of the present invention.

With the present invention, processor 602 may perform the operations for generating display screens and outputting them via the display 616, processing user input via the keypad 614, and generating messages for transmission by transmitter 608, amplifier 612, and couple 624, in accordance with the functionality previously described. The processor 602 may operate based on software instructions and data stored in memory 604.

FIG. 7 is an exemplary block diagram of the primary operational elements of a service provider computing device in accordance with one embodiment of the present invention. The elements shown in FIG. 7 may be implemented in hardware, software, or any combination of hardware and software. For example, in a preferred embodiment, the elements shown in FIG. 7 are implemented as software instructions executed by one or more data processing devices.

As shown in FIG. 7, the service provider computing device includes a controller 710, a communications network interface 720, a wireless network interface 730, a home location register interface 740, a visitor location register interface 750, a messaging module 760, and a subscriber profiles database interface 770. The elements 710-770 are in communication with one another via the control/data signal bus 780. Although a bus architecture is shown in FIG. 7, the present invention is not limited to such and any architecture that facilitates the communication of control/data signals between the elements 710-770 may be used without departing from the spirit and scope of the present invention.

The controller 710 controls the overall operation of the service provider computing device and orchestrates the operation of the other elements 720-770. The communications network interface 720 provides an interface through which communication connection requests are received and messages are output to communication devices via a communications network. The wireless network interface 730 provides an interface through which power-off messages may be received from mobile communication devices and handshake operations may be performed. The home and visitor location register interfaces 740 and 750 are provided for accessing registers of mobile communication devices to update and check the status of mobile communication devices.

Of particular interest to the present invention are the messaging module 760 and the subscriber profiles database interface 770. The messaging module 760 is used to select/generate messages for output to communication devices that have requested a communication connection to a mobile communication device that is in a power-off state. The messaging module 760 performs a lookup of an appropriate message to output based on a reason identifier retrieved from a mobile communication device record in one of the home location and visitor location registers via the interfaces 740 and 750. The messaging module then outputs the appropriate message via the communications network interface 720 to the communication device requesting the communication connection.

The subscriber profiles database 770 is used to lookup a profile for the mobile communication device with which communication is sought. The profile may include a list of communication devices that are either allowed to be informed of the power-off state and reason for the power-off state, or a list of communication devices that are not allowed to be informed of this state and reason for the state. Whether a communication device requesting a communication connection is in this list or not is used as a basis for determining whether to output a prerecorded message indicating the power-off state and reason for the power-off state to the communication device.

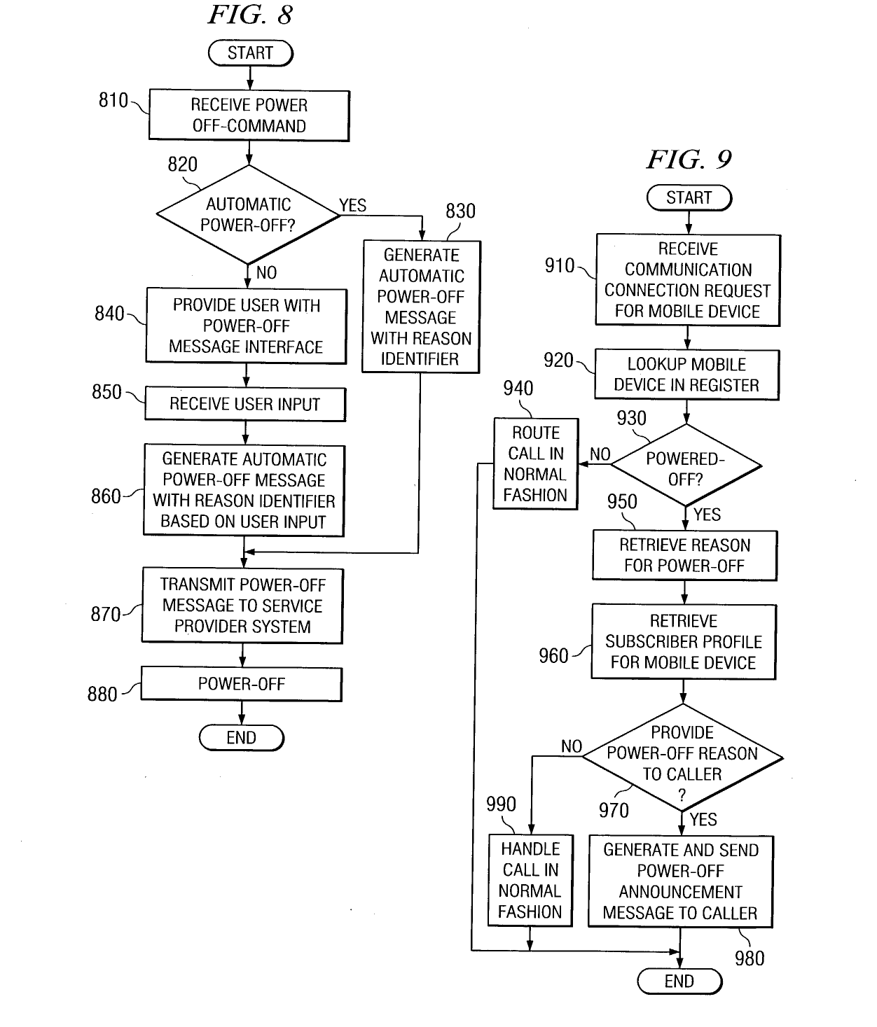

Outlines of the operations performed by the mechanisms of the present invention, such as those shown in FIGS. 6 and 7, are provided in the flowchart illustrations of FIGS. 8 and 9. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 8 is a flowchart outlining an exemplary operation of the present invention for handling a power-off of a communication device. As shown in FIG. 8, the operation starts with receipt of a power-off command (step 810). A determination is made as to whether the power-off command is due to an automatic power-off operation (step 820). If so, an automatic power off message is generated with an appropriate reason identifier (step 830).

If the power-off command is not automatic, the a power-off message interface is provided (step 840) and a user's input to the power-off message interface is received (step 850). A power-off message is then generated that includes a reason identifier that corresponds to the reason selected by the user via the power-off message interface (step 860). The power-off message is then transmitted to the service provider system (870) and the mobile communication device is powered off (step 880).

In response to the operation of FIG. 8, the service provider system receives the power-off message and updates a record for the mobile communication device indicating that power-off state and storing the associated reason identifier for the power-off state. The operation shown in FIG. 9 is performed in response to a subsequent communication connection attempt to this mobile communication device.

FIG. 9 is a flowchart outlining an exemplary operation of the present invention when handling a communication attempt to a communication device that has been powered-off. As shown in FIG. 9, the operation starts by receiving a communication connection request for a mobile communication device (step 910). The mobile communication device's record is then looked up in an appropriate register (step 920). A determination is then made as to whether the mobile communication device's current status is a powered-off status (step 930).

If the mobile communication device is not powered-off, then the communication connection request is routed in a normal fashion (step 940). If the mobile communication device is powered-off, then the reason for the powered-off state is retrieved (step 950). The subscriber profile for the mobile communication device is also retrieved (step 960) and a determination is made as to whether the power-off state and reason may be provided to the sender of the communication connection request (step 970).

If not, the call is handled in a normal fashion (step 990), e.g., sent to a voicemail service. If the power-off state and reason may be provided to the sender of the communication connection request, then a power-off announcement message indicating the state and reason are generated and sent to the sender of the communication connection request (step 980). The operation then terminates.

Thus, the present invention provides a mechanism by which a caller or originator of a communication connection request may be informed of the power-off state of a user's mobile communication device and the reason for such a power-off state. In this way, the caller is provided with more information by which the caller may determine how best to attempt the contact with the user again.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of informing a user of an initiator device of a communication connection, of a power-off state of a recipient communication device, comprising:
receiving a communication connection request from the initiator device directed to the recipient communication device;
determining if the recipient communication device is in a power-off state; and
outputting a message to the initiator device indicating the recipient communication device to be in a power-off state in response to a determination that the recipient communication device is in a power-off state.

2. The method of claim 1, wherein the message further includes an indicator of a reason for the power-off state of the recipient communication device.

3. The method of claim 1, wherein determining if the recipient communication device is in a power-off state includes:
retrieving a record associated with the recipient communication device, the record including an indicator of a current state of the recipient communication device; and
determining if the indicator of the current state of the recipient communication device is set to a power-off state value.

4. The method of claim 3, wherein the record further includes an indicator of a reason for a power-off state of the recipient communication device.

5. The method of claim 4, wherein outputting the message further includes:
retrieving a prerecorded message based on the indicator of the reason for the power-off state; and
generating the message based on the retrieved prerecorded message.

6. The method of claim 4, wherein the indicator of the reason for the power-off state of the recipient communication device is set based on a power-off message received from the recipient communication device.

7. The method of claim 6, wherein the message includes the indicator of the reason for the power-off state of the recipient communication device.

8. The method of claim 7, wherein the indicator of the reason for the power-off state corresponds to a reason entered by a user of the recipient communication device.

9. The method of claim 7, wherein the indicator of the reason for the power-off state corresponds to a reason automatically determined by the recipient communication device.

10. The method of claim 8, wherein the user of the recipient communication device enters the reason by selecting a reason from a plurality of predetermined options associated with a power-off function of the recipient communication device.

11. A computer program product in a computer readable medium for informing a user of an initiator device of a communication connection of a power-off state of a recipient communication device, comprising:
first instructions for receiving a communication connection request from the initiator device directed to the recipient communication device;
second instructions for determining if the recipient communication device is in a power-off state; and
third instructions for outputting a message to the initiator device indicating the recipient communication device to be in a power-off state in response to a determination that the recipient communication device is in a power-off state.

12. The computer program product of claim 11, wherein the message further includes an indicator of a reason for the power-off state of the recipient communication device.

13. The computer program product of claim 11, wherein the second instructions for determining if the recipient communication device is in a power-off state include:
instructions for retrieving a record associated with the recipient communication device, the record including an indicator of a current state of the recipient communication device; and
instructions for determining if the indicator of the current state of the recipient communication device is set to a power-off state value.

14. The computer program product of claim 13, wherein the record further includes an indicator of a reason for a power-off state of the recipient communication device.

15. The computer program product of claim 14, wherein the third instructions for outputting the message further include:
instructions for retrieving a prerecorded message based on the indicator of the reason for the power-off state; and
instructions for generating the message based on the retrieved prerecorded message.

16. The computer program product of claim 14, wherein the indicator of the reason for the power-off state of the recipient communication device is set based on a power-off message received from the recipient communication device.

17. The computer program product of claim 16, wherein the message includes the indicator of the reason for the power-off state of the recipient communication device.

18. The computer program product of claim 17, wherein the indicator of the reason for the power-off state corresponds to a reason entered by a user of the recipient communication device.

19. The computer program product of claim 17, wherein the indicator of the reason for the power-off state corresponds to a reason automatically determined by the recipient communication device.

20. An apparatus for informing a user of an initiator device of a communication connection of a power-off state of a recipient communication device, comprising:
means for receiving a communication connection request from the initiator device directed to the recipient communication device;
means for determining if the recipient communication device is in a power-off state; and
means for outputting a message to the initiator device indicating the recipient communication device to be in a power-off state in response to a determination that the recipient communication device is in a power-off state.
